(19) United States
(12) Patent Application Publication
(10) Pub. No.: US 2019/0086505 A1
(43) Pub. Date: Mar. 21, 2019

(54) METHODS FOR ESTIMATING ANGLE OF ARRIVAL OR ANGLE OF DEPARTURE

(71) Applicant: QUALCOMM Incorporated, San Diego, CA (US)

(72) Inventors: Rahul MALIK, San Diego, CA (US); Carlos Horacio ALDANA, Mountain View, CA (US); Hemanth SAMPATH, San Diego, CA (US)

(21) Appl. No.: 15/710,242

(22) Filed: Sep. 20, 2017

(51) Int. Cl. G01S 3/14; H04L 29/06

(52) U.S. Cl. CPC G01S 3/143; H04L 69/22

(57) ABSTRACT

Certain aspects of the present disclosure provide methods and apparatus for estimating angular information, such as angle of arrival (AoA) information or angle of departure (AoD) information.

### FIELD

Certain aspects of the present disclosure generally relate to wireless communications and, more particularly, to enhancing positioning procedures.

### BACKGROUND

In order to address the issue of increasing bandwidth requirements demanded for wireless communications systems, different schemes are being developed to allow multiple user terminals to communicate with a single access point by sharing the channel resources while achieving high data throughputs.

Certain applications, such as virtual reality (VR) and augmented reality (AR) may demand data rates in the range of several Gigabits per second. Certain wireless communications standards, such as the Institute of Electrical and Electronics Engineers (IEEE) 802.11standard. The IEEE 802.11 standard denotes a set of Wireless Local Area Network (WLAN) air interface standards developed by the IEEE 802.11 committee for short-range communications (e.g., tens of meters to a few hundred meters).

Amendment 802.11ad to the WLAN standard defines the MAC and PHY layers for very high throughput (VHT) in the 60 GHz range. Operations in the 60 GHz band allow the use of smaller antennas as compared to lower frequencies. However, as compared to operating in lower frequencies, radio waves around the 60 GHz band have high atmospheric attenuation and are subject to higher levels of absorption by atmospheric gases, rain, objects, and the like, resulting in higher free space loss. The higher free space loss can be compensated for by using many small antennas, for example arranged in a phased array.

Using a phased array, multiple antennas may be coordinated to form a coherent beam traveling in a desired direction (or beam), referred to as beamforming. An electrical field may be rotated to change this direction. The resulting transmission is polarized based on the electrical field. A receiver may also include antennas which can adapt to match or adapt to changing transmission polarity.

Some protocols have been devised that use such directional transmissions to passively determine relatively accurate (absolute or relative) information that may be used to estimate positions of devices. For example, estimates of Angle of arrival (AoA) and angle of departure (AoD) of directional transmissions may be used to estimate a “line of bearing” allowing estimate of relative position and/or orientation of the devices. If the location and orientation of one of the devices is fixed (and known to the other device), the position of the other device may be estimated based on the AoA and/or AoD information.

AoA and AoD capability of a detecting device may lead to improved positioning accuracy with reduced overhead on the network. This is because, unlike other algorithms, such as fine timing measurement (FTM), positioning based on AoA and/or AoD measurements can be practiced without requiring back and forth packet exchanges between devices. In other words, the detecting device should be able to assess the AoA/AoD based on ‘any’ transmission (or set of transmissions) from the device to be detected.

Given the angular information (whether AoA, AoD, or both) from transmitters at known locations (e.g., access points or base stations), the position of a wireless device may be readily determined (e.g., using triangulation).

### SUMMARY

Certain aspects of the present disclosure provide methods and apparatus relating to distribution networks that utilize point-to-point communication between devices.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof

Certain aspects of the present disclosure provide an apparatus for wireless communications. The apparatus generally includes an interface configured to detect a plurality of packets via at least two signal paths and a processing system. The processing system is generally configured to determine phase differences for the plurality of packets, wherein the phase difference for each packet is determined based on a difference in time that the packet was detected, and estimate angular information for the packets based on (a statistical analysis of) at least one of: the phase differences or parameters generated based on the phase differences.

Certain aspects of the present disclosure provide a method for wireless communications by an apparatus. The method generally includes detecting a plurality of packets via at least two signal paths, determining phase differences for the plurality of packets, wherein the phase difference for each packet is determined based on a difference in time that the packet was detected, and estimating angular information for the packets based on (a statistical analysis of) at least one of: the phase differences or parameters generated based on the phase differences.

Certain aspects of the present disclosure provide an apparatus for wireless communications. The apparatus generally includes means for detecting a plurality of packets via at least two signal paths, means for determining phase differences for the plurality of packets, wherein the phase difference for each packet is determined based on a difference in time that the packet was detected, and means for estimating angular information for the packets based on (a statistical analysis of) at least one of: the phase differences or parameters generated based on the phase differences.

Certain aspects of the present disclosure provide a wireless station. The wireless station generally includes a receiver configured to detect a plurality of packets via at least two signal paths and a processing system. The processing system is generally configured to determine phase differences for the plurality of packets, wherein the phase difference for each packet is determined based on a difference in time that the packet was detected, and estimate angular information for the packets based on (a statistical analysis of) at least one of: the phase differences or parameters generated based on the phase differences.

Certain aspects of the present disclosure provide a computer readable medium having instructions stored thereon for detecting a plurality of packets via at least two signal paths, determining phase differences for the plurality of packets, wherein the phase difference for each packet is determined based on a difference in time that the packet was detected, and estimating angular information for the packets based on (a statistical analysis of) at least one of: the phase differences or parameters generated based on the phase differences.

Aspects of the present disclosure also provide various methods, means, and computer program products corresponding to the apparatuses and operations described above.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in accordance with certain aspects of the present disclosure.

FIG. 2 is a block diagram of an example access point and example user terminals, in accordance with certain aspects of the present disclosure.

FIG. 3 is a diagram illustrating signal propagation in an implementation of phased-array antennas, in accordance with certain aspects of the present disclosure.

FIG. 4 illustrates an example system in which aspects of the present disclosure may be practiced.

FIG. 5A illustrates an example transmission that may be used to measure angle of arrival (AoA), in accordance with certain aspects of the present disclosure.

FIG. 5B illustrates an example transmission that may be used to measure angle of departure (AoD), in accordance with certain aspects of the present disclosure.

FIG. 6 illustrates an example multipath transmission that may be used to measure AoA or AoD, in accordance with certain aspects of the present disclosure.

FIG. 7 illustrates an example channel impulse response corresponding to the transmission shown in FIG. 6.

FIG. 8 illustrates an example distribution of phase difference measurements that may be used to estimate angular information, in accordance with certain aspects of the present disclosure

FIG. 9 illustrates example operations for estimating angular information, in accordance with certain aspects of the present disclosure.

FIG. 9A illustrates example components capable of performing the operations shown in FIG. 9.

FIG. 10 illustrates an example probability density function of phase difference measurements, in accordance with certain aspects of the present disclosure.

FIG. 11 illustrates an example relationship between angle of arrival (AoA) values and phase difference values, in accordance with certain aspects of the present disclosure.

FIG. 12 illustrates an example probability density function of AoA values, in accordance with certain aspects of the present disclosure.

### DETAILED DESCRIPTION

Certain aspects of the present disclosure provide methods and apparatus for performing positioning based on directional transmissions.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. The techniques described herein may be utilized in any type of applied to Single Carrier (SC) and SC-MIMO systems.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

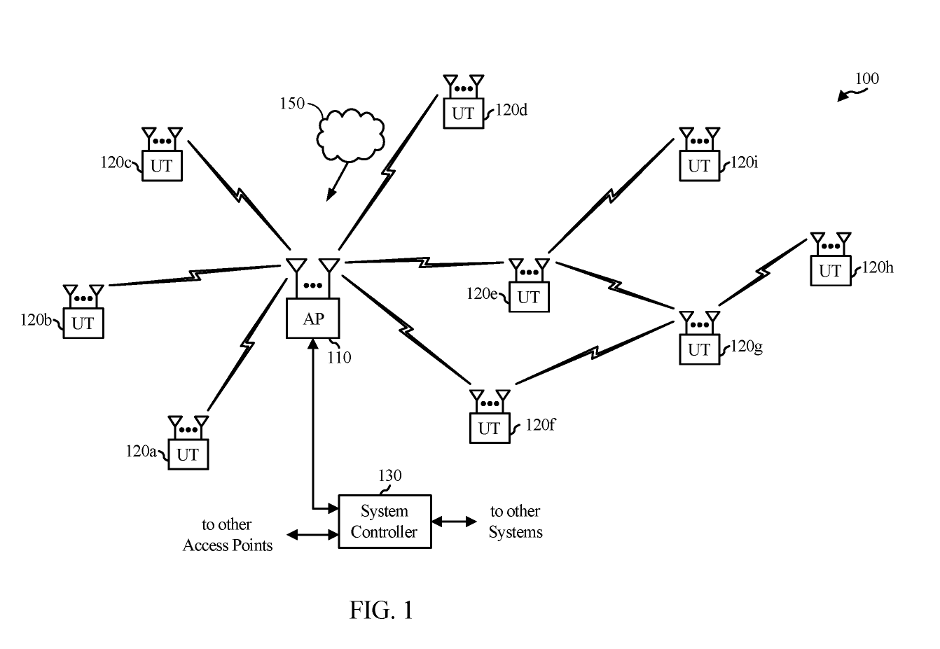

FIG. 1 illustrates a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an access point (AP) 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≥K≥1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≥1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

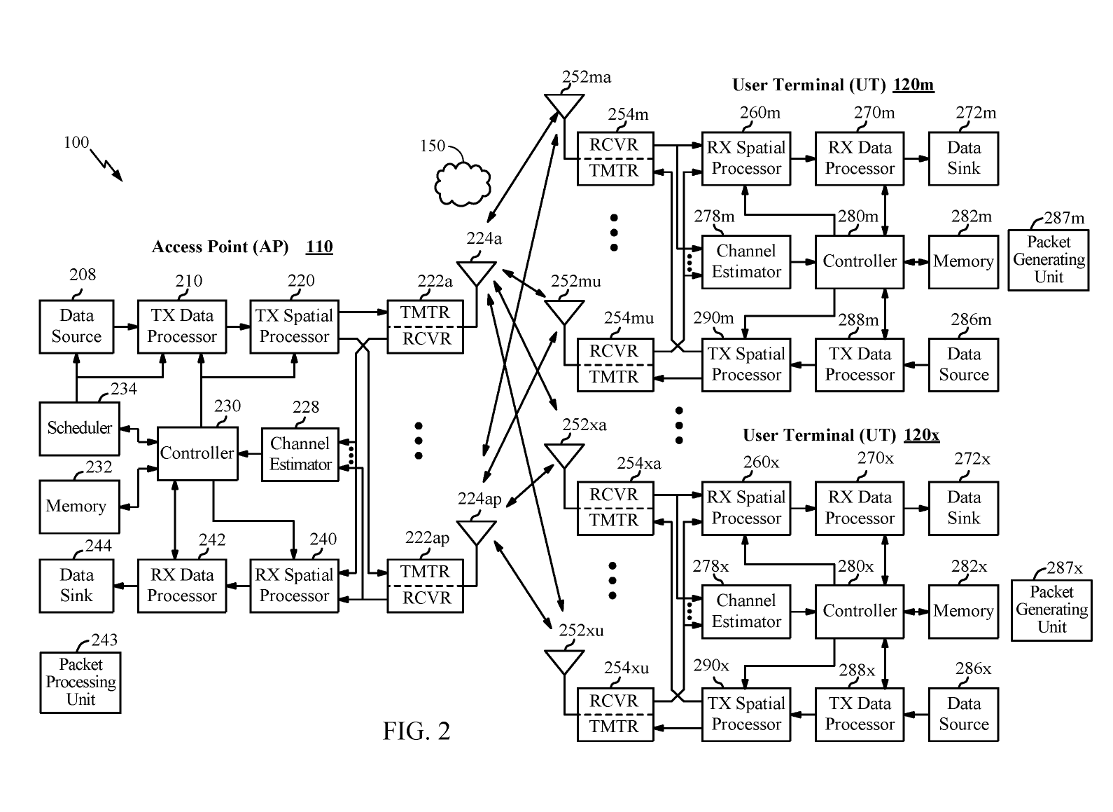

FIG. 2 illustrates a block diagram of access point 110 and two user terminals 120m and 120x in MIMO system 100. The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. The term communication generally refers to transmitting, receiving, or both. In the following description, the subscript “dn” denotes the downlink, the subscript “up” denotes the uplink, Nup user terminals are selected for simultaneous transmission on the uplink, Ndn user terminals are selected for simultaneous transmission on the downlink, Nup may or may not be equal to Ndn, and Nup and Ndn may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nup user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nup user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nup recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for Ndn user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides Ndn downlink data symbol streams for the Ndn user terminals. A TX spatial processor 220 performs spatial processing (such as a precoding or beamforming, as described in the present disclosure) on the Ndn downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

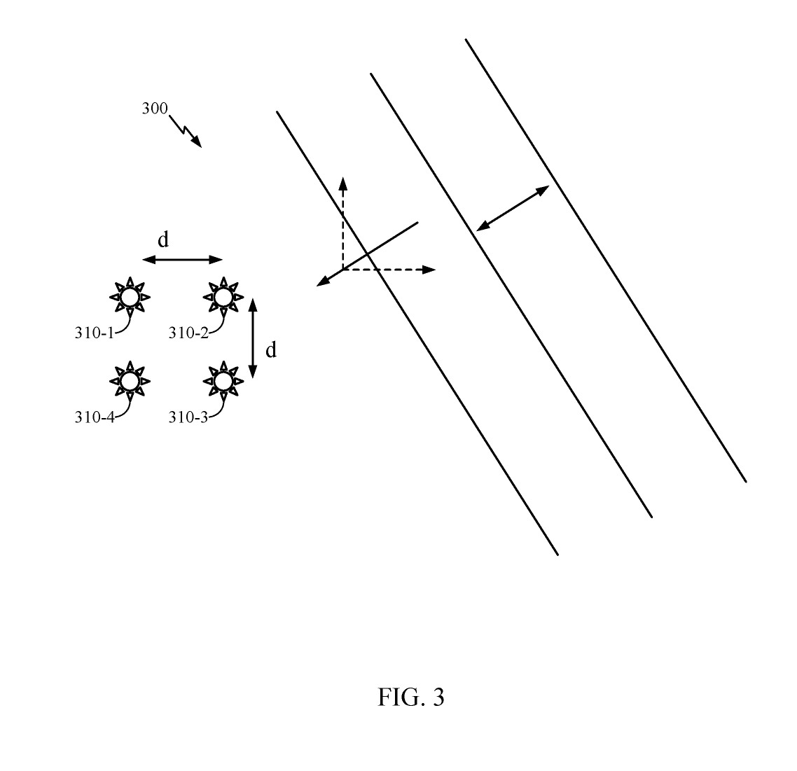

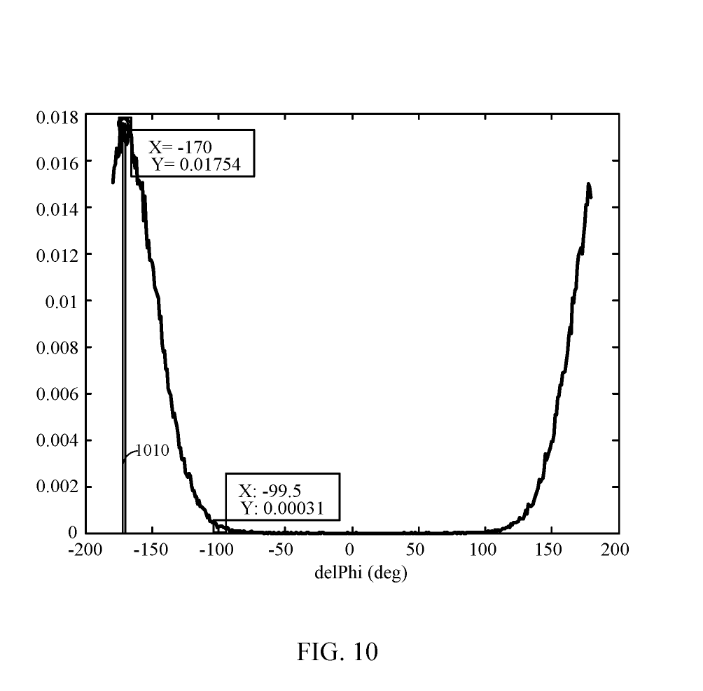

As illustrated, in FIGS. 1 and 2, one or more user terminals 120 may send one or more generated High Efficiency WLAN (HEW) packets 150, with a preamble format as described herein (e.g., in accordance with one of the example formats shown in FIGS. 3A-3B), to the access point 110 as part of a UL MU-MIMO transmission, for example. Each HEW packet 150 may be transmitted on a set of one or more spatial streams (e.g., up to 4). For certain aspects, the preamble portion of the HEW packet 150 may include tone-interleaved LTFs, subband-based LTFs, or hybrid LTFs (e.g., in accordance with one of the example implementations illustrated in FIGS. 10-13, 15, and 16).

The HEW packet 150 may be generated by a packet generating unit 287 at the user terminal 120. The packet generating unit 287 may be implemented in the processing system of the user terminal 120, such as in the TX data processor 288, the controller 280, and/or the data source 286.

After UL transmission, the HEW packet 150 may be processed (e.g., decoded and interpreted) by a packet processing unit 243 at the access point 110. The packet processing unit 243 may be implemented in the process system of the access point 110, such as in the RX spatial processor 240, the RX data processor 242, or the controller 230. The packet processing unit 243 may process received packets differently, based on the packet type (e.g., with which amendment to the IEEE 802.11 standard the received packet complies). For example, the packet processing unit 243 may process a HEW packet 150 based on the IEEE 802.11 HEW standard, but may interpret a legacy packet (e.g., a packet complying with IEEE 802.11a/b/g) in a different manner, according to the standards amendment associated therewith.

Certain standards, such as the IEEE 802.1lay standard currently in the development phase, extend wireless communications according to existing standards (e.g., the 802.11ad standard) into the 60 GHz band. Example features to be included in such standards include channel aggregation and Channel-Bonding (CB). In general, channel aggregation utilizes multiple channels that are kept separate, while channel bonding treats the bandwidth of multiple channels as a single (wideband) channel.

As described above, operations in the 60 GHz band may allow the use of smaller antennas as compared to lower frequencies. While radio waves around the 60 GHz band have relatively high atmospheric attenuation, the higher free space loss can be compensated for by using many small antennas, for example arranged in a phased array.

Using a phased array, multiple antennas may be coordinated to form a coherent beam traveling in a desired direction. An electrical field may be rotated to change this direction. The resulting transmission is polarized based on the electrical field. A receiver may also include antennas which can adapt to match or adapt to changing transmission polarity.

FIG. 3 is a diagram illustrating signal propagation 300 in an implementation of phased-array antennas. Phased array antennas use identical elements 310-1 through 310-4 (hereinafter referred to individually as an element 310 or collectively as elements 310). The direction in which the signal is propagated yields approximately identical gain for each element 310, while the phases of the elements 310 are different. Signals received by the elements are combined into a coherent beam with the correct gain in the desired direction.

### Example Methods for Estimating Angle of Arrival or Angle of Departure

Aspects of the present disclosure provide techniques that may be used to estimate angular information, such as Angle of Arrival (AoA) or Angle of Departure (AoD) of transmissions between devices. As will be described herein, in some cases, accuracy of the angular information may be estimated by performing statistical analysis of phase difference measurements or angular information estimated therefrom. For example, taking the mode of such parameters (e.g., rather than a mean) may yield a more accurate result.

AoA and/or AoD based positioning may have various benefits, such as improved positioning accuracy, reduced receive-side capability requirements, and reduced network overhead. For example, positioning based on angular information (AoA and/or AoD) may be practiced without requiring back and forth packet exchanges between detecting and detected devices. In other words, the detecting device should be able to assess the AoA/AoD based on ‘any’ transmission.

Such position estimates may be used for a variety of purposes, such as updating scene information in VR or AR applications, based on relative position or orientation of a wireless device. In such cases, the position estimate may be passed on to an application layer. As another example, a position may be reported back to a network entity (e.g., an AP or central controller) for tracking a wireless device. As still another example, an estimated position may be used to determine available services in an area.

Estimated angular information, based on multiple receive paths (AoA) or transmit paths (AoD), may be used as a component to determine location in a number of different ways. In some cases, a wireless device may use estimated angular information in the process of computing its own location or the location of a peer (e.g., a peer whose angular information is being measured). In some cases, location determination may require multiple inputs, with angular information being one of the inputs. For example, in some cases, a STA may measure the AoA/AoD with respect to one or more APs and, knowing the location of (and/or distance to) the APs (e.g., after obtaining signaling indicating the location), that STA could compute its own location (e.g., based on an intersection of lines using the AoA/AoD for each AP). In some cases, multiple APs may measure angular information based on a STA transmission(s) and coordinate amongst themselves to compute the location of the STA within the network. In some cases, a STA may provide feedback regarding angular information (generated based on packets) to a peer that is a source of those packets. In such cases, the peer device may use the angular information to determine a location. For example, the peer device may determine its own location, based on the angular information and a known location of the STA or the peer device may determine a location of the STA based on the angular information and a known location of the peer.

In some cases, angular information may be combined with other information to determine a location. For example, an AP may combine angular information with round-trip travel time (RTT) information with AoA information from a STA to compute that STAs location.

In any case, the techniques presented herein may be performed to estimate angular information based on transmissions that naturally occur (e.g., received 2.4/5 GHz packets). For example, certain applications like Virtual Reality and Augmented Reality typically involve a high volume of packets for data transactions (e.g., updating sensor information, controlling actuators, and the like). These packets provide opportunities for passive positioning, for example, based on AoA and/or AoD estimates generated using the techniques presented herein.

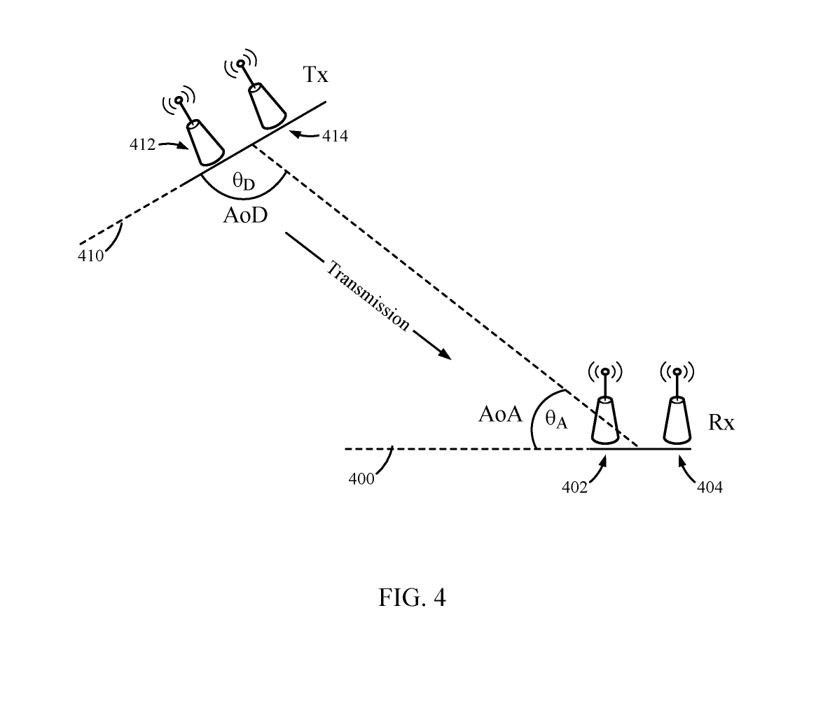

As illustrated in FIG. 4, AoD (θ_{D}) generally refers to the angle formed between a reference line 410 (extending between antenna elements 412, 414 at a transmitter) and the direction of a transmitted signal to one or more antenna elements 402, 404, at a receiver. AoA (θ_{A}) generally refers to the angle formed between a reference line 400 (extending between antenna elements 402, 404) and the direction of the signal as received at antenna elements 402, 404. The angular information may be estimated based on phase differences between the transmitter and receiver due to the transmitted signal traveling different signal paths.

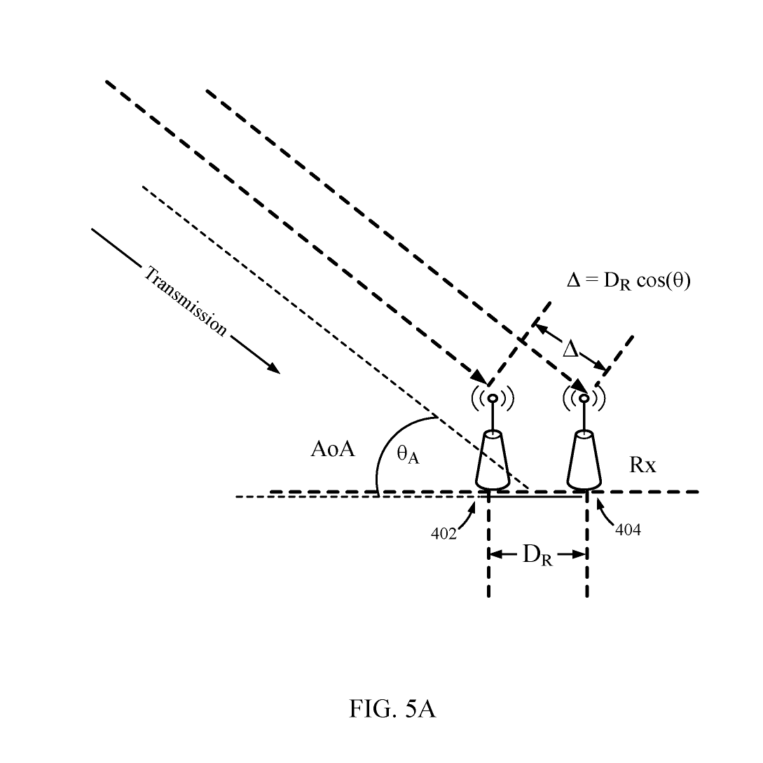

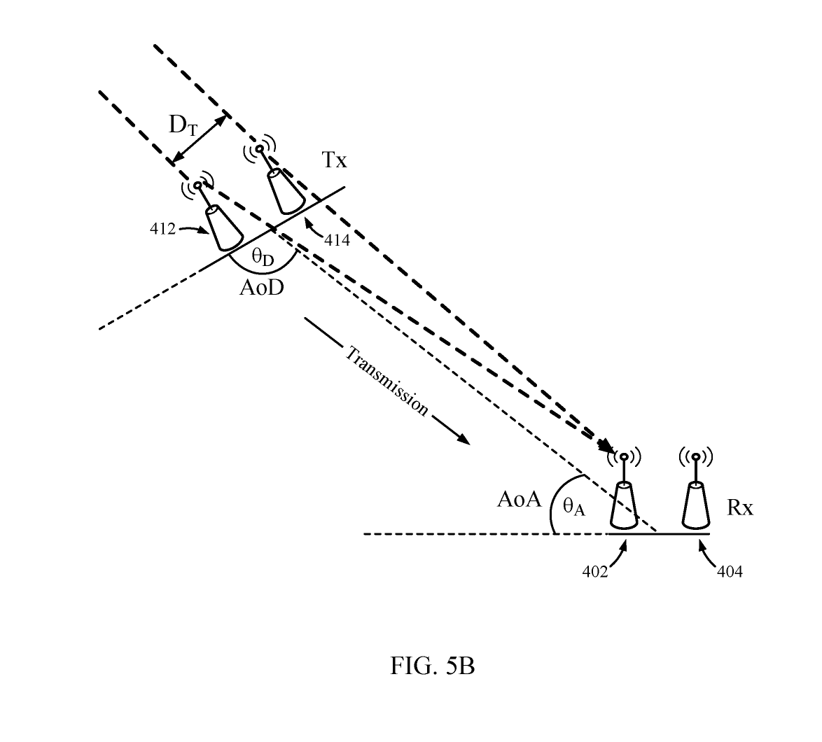

In general, AoA determination techniques rely on measuring phase differences from a transmitter to multiple receivers. For example, as illustrated in FIG. 5A, due to the spacing (D_{R}) between receive antenna elements 402 and 404, a signal transmitted from one of the transmit antenna elements arrives at the receive antennas at slightly different times, or out of phase, resulting in a phase difference. In the illustrated example, the phase difference is caused by the signal traveling a greater distance to reach receive antenna 404 relative to receive antenna 402, with the difference in distance related to the antenna element spacing and AoA can be expressed as:

Δ=D_{R} cos(θ_{A}),

while the phase difference (ΔPhase) can be expressed as:

ΔPhase=2πD_{R} cos(θ_{A})/λ,

where λ is the wavelength of the transmitted signal. This equation may be simplified, for example, if it can be assumed that D_{R}≈λ/2, resulting in:

ΔPhase=π cos(θ_{A})/λ

Given the phase information of the received signal, the receiving device may estimate the AoA using any suitable techniques.

AoD determination techniques rely on measuring phase differences from multiple transmitters as seen by a receiver. For example, as illustrated in FIG. 5B, due to the spacing (D_{T}) between transmit antenna elements 412 and 414, signals transmitted from the transmit antenna elements 412 and 414 arrives at the same receive antenna element 402 with a measureable phase difference. Given the phase information of the received signal, the receiving device may estimate AoD using any suitable techniques.

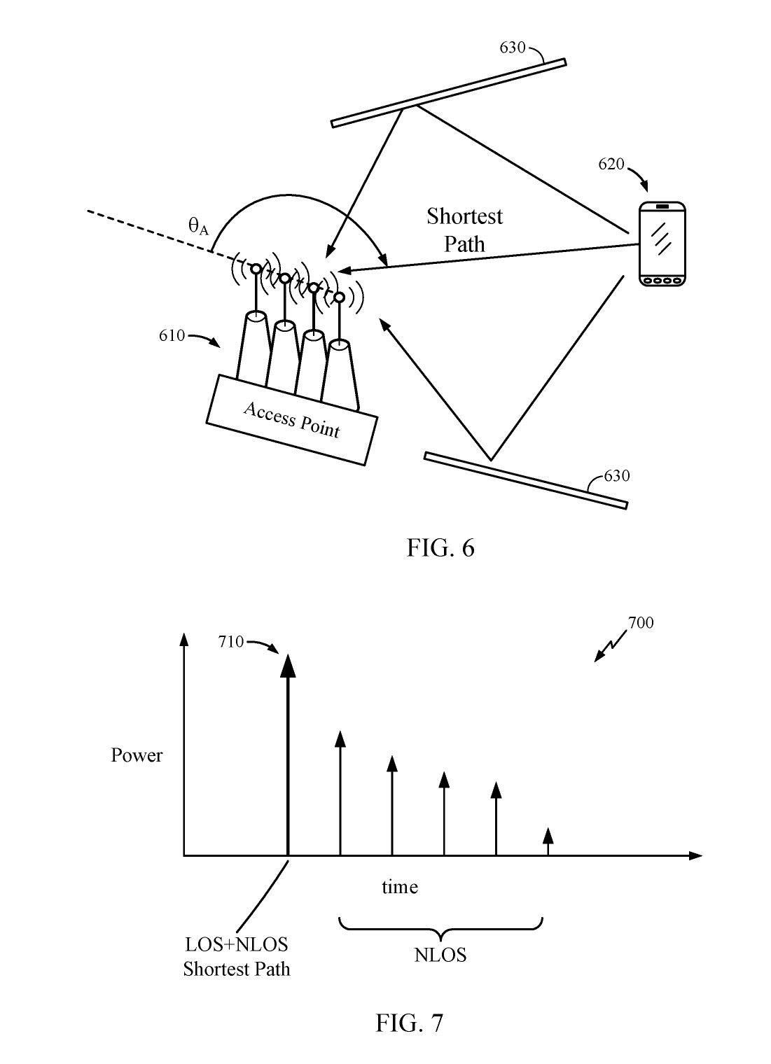

FIG. 6 illustrates one example scenario, in which AoA may be estimated at an access point (AP) 610, based on transmissions (e.g., packets) from a wireless device (e.g., a mobile station) 620. As illustrated, transmissions reach the AP 610 via multiple signal paths. The multiple signal paths include a direct path (sometimes referred to as line-of-sight or LOS), as well as indirect paths (sometime referred to as non-line-of-sight or NLOS) due to reflections from various surrounding objects 630 (e.g., walls or buildings). As illustrated, the shortest path typically corresponds to the direct path whose angle (θ_{A}) corresponds to the AoA to be measured, as that will yields the line of bearing, between the AP 610 and the wireless device 620.

As illustrated in FIG. 7, a typical channel impulse response 700 includes multiple channel taps corresponding to the signal and its reflections from various surrounding objects. As used herein, a channel tap generally refers to a point in time the received signal is sampled and corresponds to a certain delay, such that the set of channel taps spans some duration in time (e.g., with the number of channel taps and spacing designed to reduce/eliminate noisy taps due to reflections). The impulse response of the channel may be obtained by taking the inverse discrete Fourier transform (IDFT) of the channel frequency response.

A first step in determining angular information (AoA/AoD) based on a received packet may be to identify the first channel tap which, as indicated in FIG. 7, may carry the phase-difference of the direct path that is related to the angle to be measured. Identifying the first tap may be aided by accurate timing measurements.

In some cases, auto-correlation detectors may be used for timing measurements (e.g., because they may be relatively inexpensive to implement and provide accurate performance) for first-tap detection. In order to simply receive a packet, the timing may only need to be good enough to be able to place the FFT window to start within a cyclic prefix (CP) of the packet.

For accurate AoA measurement, however, the first tap detection may need to be as good as the sample resolution. If the end of the CP can be identified, as well as the start of the packet, the timing window can be placed at this point and the first tap of the impulse response of the channel will corresponds to the first arrival. If timing is off from this point, however, the effect may be equivalent to shifting the impulse response making identification of the first tap more difficult.

In some cases, aspects of the present disclosure address this potential problem by implementing a cross-correlation based detector (rather than an auto-correlator) that is activated when a packet is detected. Such a cross-correlation based detector may or may not operate in real-time. In other words, because AoA measurements may not need to be determined immediately, the detector may operate on saved analog to digital converter (ADC) samples in the background.

In general, the cross-correlation based detector looks for known sections (sections that have a known sequence) of the samples, such as a long training field (LTF) and correlation peaks will correspond to alignment of the known sequence. This will allow for precise timing location of the LTF and, using that, the IFFT may be aligned, reducing or eliminating the problem of shifting the impulse response. The cross-correlation based detector may also be used to refine timing (e.g., based on subsequently detected known sections of the packet). Cross-correlation of CPs across packets may be used to refine timing.

In some cases, a detector may be implemented that, in effect, acts as a large matched filter, based on known sections of the packet to accurately determine the end of the CP and the start of the symbol of the packet. In some cases, the matched filter may be dynamically constructed based on demodulated portions of the packet (e.g., L-SIG, HT/VHT/HEW SIGs fields). In some cases, a matched filter approach may be combined with cross-correlation.

In any case, more accurate first tap detection may lead to more accurate phase difference information and, hence, more accurate angle estimates. Once determined (e.g., over a number of packets), the observed phase differences may be used to obtain an AoA or estimate. Generally, any suitable algorithm may be used to process the received packet channel impulse response to determine AoA or AoD. Examples of such algorithms include MUSIC, Bartlett, Capon, ESPRIT, Root-MUSIC and others. In some cases, device capability or cost may determine which algorithm is used. For example, in some cases, the Bartlett method may be preferred (e.g., over MUSIC or others) due to relatively low computational complexity.

In some cases, phase differences may be calibrated in a factory environment to generate a database for various positions (corresponding to different angles of arrival). Upon receiving a packet (or packets), the determining phase difference may be correlated against this database to identify the AoA.

### Statistical Processing of First-Tap to Determine AoA/AoD

As described previously, detection of the first-tap of the channel impulse response may be a first step in determining angular information, such as AoA/AoD. Multi-path effects, however, may present a challenge for this detection, as contributions to the first-tap by indirect signal paths may cause the signal from the reflected paths may perturb the true phase difference, resulting in erroneous instantaneous phase difference measurements and corresponding angle estimates. These effects may make it difficult to perform accurate first-tap detection in scenarios where indirect and direct path differences are significant relative to tap spacing (e.g., 5 GHz systems, with a relatively low sampling rate may have a tap spacing of 25 ns may have difficulty resolving path differences within 25 feet).

Aspects of the present disclosure, however, provide processing techniques that may account for this effect and, thus, yield more accurate phase difference and/or angle estimates. The processing techniques proposed herein may account for known or observed features of the distribution of phase difference and/or angle estimates over multiple packets in a sample set.

For example, as indirect path contributions to an impulse response may result in a bi-modal distribution of phase difference measurements (or angle estimates obtained therefrom), a mode function “mode( )” may be utilized to select a most dominantly occurring value (or “binned” set of values, if the phase differences are processed to generate bins, based on a suitable binning size) in the distribution. Using a bin, rather than a single value may help address the case where multiple values occur with the same amount. For example, if a device measures 5 AoAs of 10°, 20°, 30°, 31°, and 32°, each of these values occur once, making it unclear how to choose a single value. However, if these values were binned, for example, in steps (binning size) of 10° (e.g., 0-10°; 10-20°; 20-30°, 30-40°, etc.) then the 30-40° bin would have the most frequently occurring values and a representative value (e.g., the midpoint of 35° could be chosen as the estimate of the AoA. Whether using a single value or a binned value, using the mode of the phase differences for a sample set and/or using the mode of the angle estimates for the sample set, may result in an angle estimate that more closely matches a true angle of interest (than an angle estimated using some other technique).

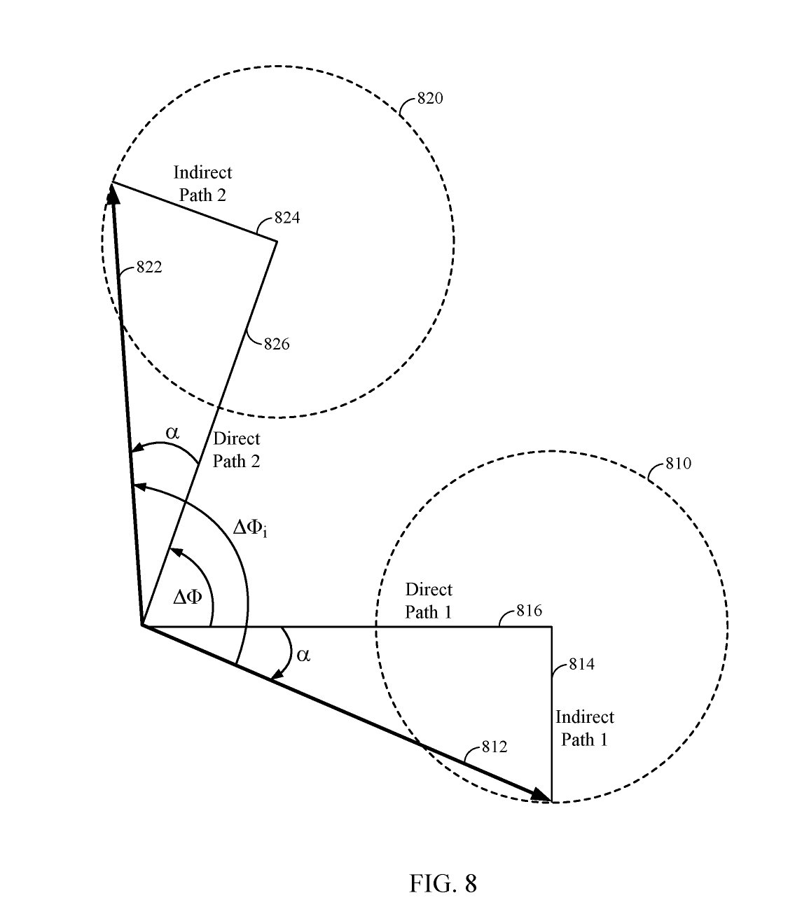

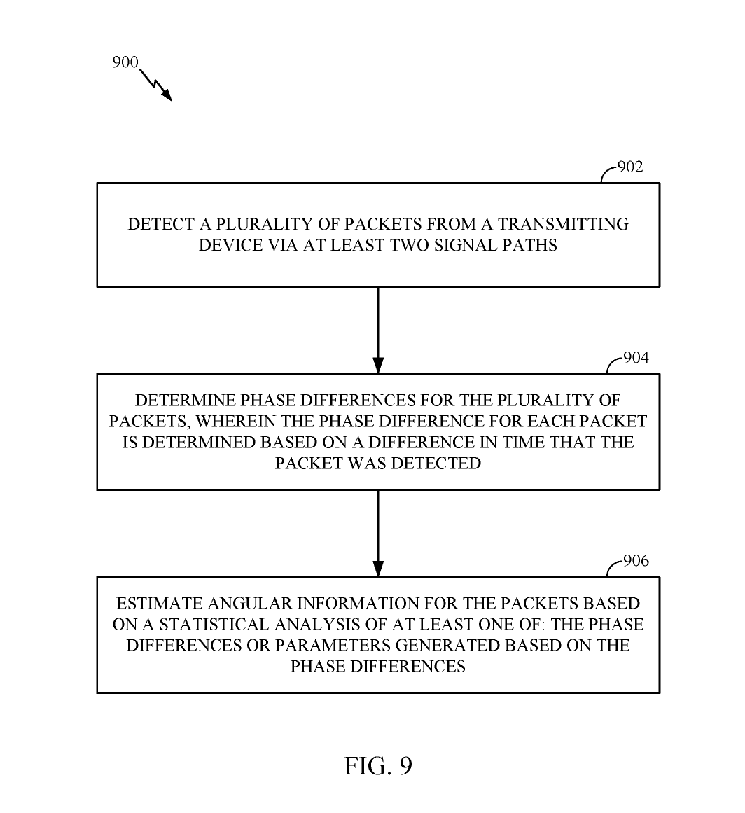

FIG. 8 demonstrates the above-referenced multi-path effects on angle of arrival (AoA) measurements based on a channel impulse response measured on 2 antennas. As illustrated, the measured response 812 from a first antenna (Ant 1), at any particular sampling instance, can be modeled as a sum of a direct signal path component vector 816 and an indirect signal path component vector 814. Similarly, the measured response 822 from a second antenna (Ant 2) can be modeled as a sum of a direct signal path component vector 826 and an indirect signal path component vector 824.

The phase difference Δφ between the direct path components 816 and 826 is related to the true angle information (e.g., AoA). As illustrated, for any given sampling instance i, the signal from the reflected paths may perturb the true phase difference Δφ, resulting in an erroneous instantaneous phase difference Δφᵢ.

The direct path components for Ant 1 and Ant 2 should remain relatively constant across a sample set of packets, while the indirect signal fading process results in “Rayleigh Distributed” amplitude and a relatively uniformly distributed phase, when taken over a sufficient number of packets.

As illustrated, the distribution of the instantaneous phase difference measurements Δφᵢ may be centered at the true phase difference Δφ. The amount of variation in the instantaneous phase different measurements (as indicated by the width of the radius of the circles in FIG. 8) may depend on the relative strengths of the direct and reflected paths, which may be expressed as a K-factor (a ratio of the direct path to the indirect path on the first tap may be referred to as the K1-factor). In general, the width of the distribution of Δφᵢ (indicated by angle α) is narrower for larger K1-factors (which have a smaller angle α).

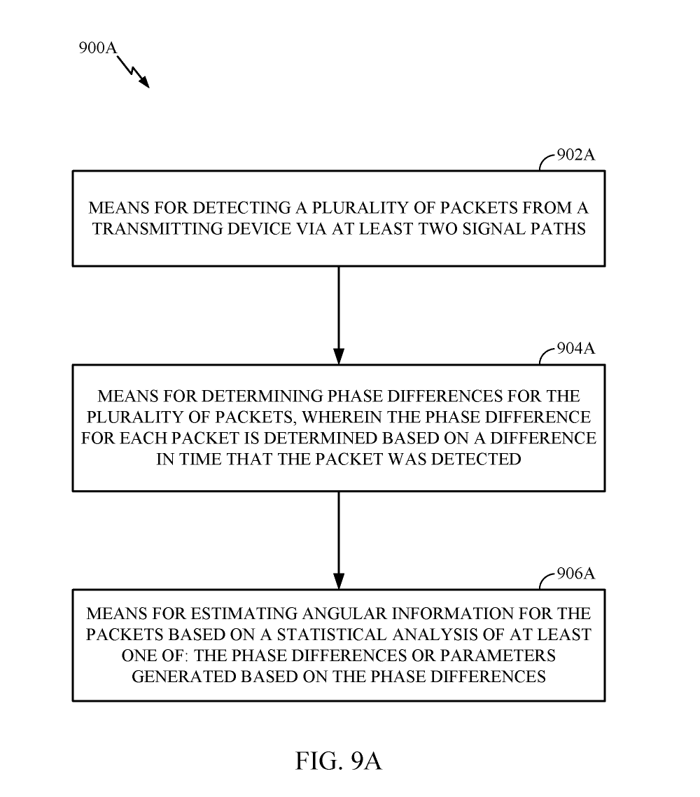

FIG. 9 illustrates example operations 900 that may be performed to estimate angle information (e.g., AoA and/or AoD) in a manner that may employ statistical processing to account for the distribution of phase difference and/or angle estimates over multiple packets in a sample set. Operations 900 may be performed any type of suitable wireless device such as a base station, mobile station, or any other type of STA (e.g., an AP or non-AP STA).

The operations 900 begin, at 902, by detecting a plurality of packets via at least two signal paths. Any suitable number of packets may be sampled and particular number in a sample set may depend on a number of factors (e.g., desired accuracy, how fast position estimates need to be updated, available system resources, and the like). As will be described below, in some cases, additional packets may be sampled (or requested), if a parameter or metric indicative of confidence in at or below a threshold value.

At 904, the wireless device determines phase differences for the plurality of packets, wherein the phase difference for each packet is determined based on a difference in time that the packet was detected (via the at least two signal paths). The phase differences may be determined, for example, using any of the approaches described above. In some cases, cross correlation and/or matched filter approaches described above may be used to improve timing for detecting the first-tap and corresponding phase information.

At 906, angular information of the packets is estimated based on (a statistical analysis of) at least one of: the phase differences or parameters generated based on the phase differences. The statistical analysis may vary, depending on the particular embodiment. In some cases, as noted above, the statistical analysis may involve calculating a mode value or mode function “mode( )” (indicative of a most often occurring value (or binned set of values) of a distribution of phase differences and/or angle estimates. In other cases, rather than perform the actual computation of the mode (which may require a significant number of packets), the mode calculation may be replaced by a parametric fit.

According to certain aspects, the statistical analysis may involve computing the mode of the distribution of the phase differences, the mode of angle estimates based on the phase differences, or both. For example, in some cases, the mode may be computed for the phase differences and the angle information may then be determined based on that phase difference mode (e.g., the mode of the phase-differences may be used to construct an updated correlation matrix for determining AoA/AoD).

In other cases, (preliminary) angle information may be estimated for each individual packet, based on the corresponding phase difference, and the mode of these individually determined angles may be used to estimate the true angle. In some cases, these two approaches may be combined, for example, and the angle estimates resulting from the different approaches may be compared as a measure of confidence (e.g., if they differ by too much, the values may be discarded or additional samples requested).

FIGS. 10-12 illustrate an example scenario, in which the statistical techniques presented herein may yield a more accurate estimate of a true angle than other approaches.

FIG. 10 illustrates an example probability density function (pdf) of phase difference measurements between two antennas distributed around an example true phase of −170 degrees (indicated by line 1010). As illustrated, a first set of phase differences are distributed around the true phase of −170° (between approx. −100° and −180°). Due to the effects of the indirect paths falling on the direct path, the phase differences between the two antennas wrap-around (180), resulting in another distribution (between approx. 100° and 180°).

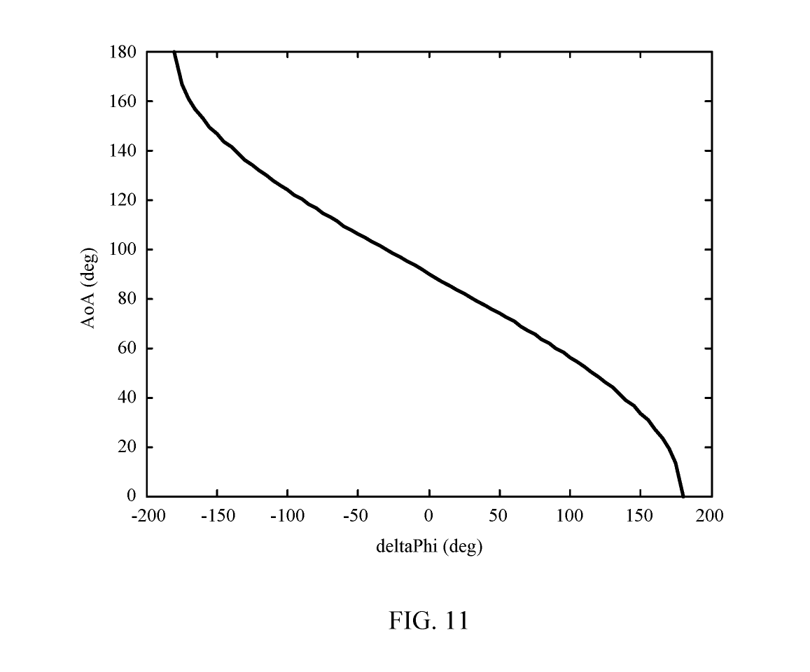

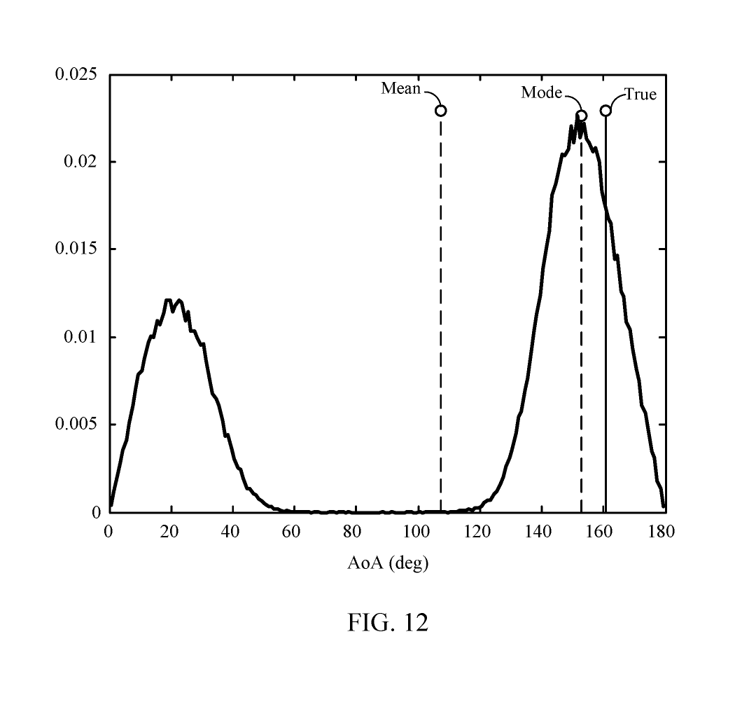

FIG. 11 illustrates an example transfer function showing a correlation between phase differential values and AoA values. Applying the transfer function of FIG. 11 to the values shown in FIG. 10, yields the bi-modal distribution of AoA values shown in FIG. 12. As illustrated, the mode operator (picking the most dominant value as the identified mode) yields a relatively accurate estimation (approx. 155°) of the true angle (approx. 160°). In contrast, the mean of the values shown in FIG. 12 would fall between (100° and 110°).

In some cases, the relative strength of the direct-path to indirect-paths on the first tap may be used as an indicator of confidence in the estimated angle. As described above, the width of the distribution (of probability density function of pdf) of the individual phase differences Acp; may depend on the K1-factor (K-factor on the first tap). Because larger K1-factors correspond to narrower distribution (and less variation), there may be a higher degree of confidence in the accuracy of corresponding angle estimates. As a result, the K1-factor may be used as the basis for a confidence parameter that may be used, for example, to determine whether to use (or discard) an angle estimate and/or to request more packets to samples.

In some cases, such a confidence parameter may be provide, for example, when reporting an angle estimate and/or a position estimated based on the angle information. A receiving device may then decide whether (or how) to use the reported value (e.g., discarding a value, requesting another report, and/or combining a value with range information). In some cases, a device may receive reports of angle and/or position estimates from different sources (e.g., many APs may detect packets from a station) and may decide, based on confidence metrics, whether and/or how to combine the different reported values (e.g., weighting them differently and/or discarding some based on the confidence metrics).

In some cases, a K-factor may be estimated. As described above, the width of the distribution of Δφ is related to the K-factor on the first tap (K1). The relationship may be expressed by the approximation:

$$tan α \approx √ ( \frac{1}{K 1} )$$

where, as described above with reference to FIG. 8, 2α corresponds to a distance from a center to an edge of a probability density function.

Various other factors may be considered when assessing confidence in an estimated angle. In some cases, the particular antennas used for the phase difference may affect the measurement confidence. For example, errors may be more likely to occur when using antennas at the edge of an array, for example, due to the effect of the arc-cos ( ) function (e.g., resulting in more AoA/AoD values represented by fewer Δφ values). Therefore, avoiding measurements near the array edge (e.g., using a shaped array) may help improve the accuracy of estimated angle information.

As described herein, statistical processing of phase difference measurements (and/or angle estimates generated therefrom) that take into account multi-path effects may help yield more accurate angle estimation.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 900 of FIG. 9 correspond to means 900A illustrated in FIG. 9A.

For example, means for obtaining may comprise a receiver (e.g., the receiver unit 222) and/or an antenna(s) 224 of the access point 110 or the receiver unit 254 and/or antenna(s) 254 of the user terminal 120 illustrated in FIG. 2. Means for detecting, means for estimating, means for measuring, means for generating, means for taking one or more actions, and/or means for determining, may comprise a processing system, which may include one or more processors, such as the RX data processor 242, the TX data processor 210, the TX spatial processor 220, and/or the controller 230 of the access point 110 or the RX data processor 270, the TX data processor 288, the TX spatial processor 290, and/or the controller 280 of the user terminal 120 illustrated in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as combinations that include multiples of one or more members (aa, bb, and/or cc).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
a first interface configured to detect a plurality of packets via at least two signal paths; and
a processing system configured to
determine phase differences for the plurality of packets, wherein the phase difference for each packet is determined based on a difference in time that the packet was detected, and
estimate angular information for the packets based on a statistical analysis of at least one of: the phase differences or parameters generated based on the phase differences.

2. The apparatus of claim 1, wherein:
the first interface is configured to obtain signaling indicating a position of a source that transmitted the packets; and
the processing system is further configured to estimate a position of the apparatus based on the angular information and the position of the source that transmitted the packets.

3. The apparatus of claim 2, wherein:
the processing system is further configured to generate a packet including the estimated position; and
the apparatus further comprises a second interface configured to output the generated packet for transmission.

4. The apparatus of claim 1, wherein:
the processing system is further configured to generate a packet including the angular information; and
the apparatus further comprises a second interface configured to output the generated packet for transmission.

5. The apparatus of claim 4, wherein:
the generated packet also includes a metric indicative of a confidence in the estimated position.

6. The apparatus of claim 1, wherein the angular information comprises angle of arrival (AoA) information.

7. The apparatus of claim 1, wherein the angular information comprises angle of departure (AoD) information.

8. The apparatus of claim 1, wherein:
the statistical analysis comprises identifying a mode of the phase differences, wherein the mode comprises a
a phase difference that occurs most often in the phase differences, or
a phase difference that corresponds to a bin of phase differences that occur most often in the phase differences; and
the processing system is configured to estimate the angular information based on the identified mode of the phase differences.

9. The apparatus of claim 1, wherein:
the parameters generated based on the phase differences comprise individual preliminary angle estimates generated for each packet based on the corresponding phase difference;
the statistical analysis comprises identifying a mode of the preliminary angle estimates, wherein the mode comprises a
a preliminary angle estimate that occurs most often in the angle estimates, or
a preliminary angle estimates that corresponds to a bin of preliminary angle estimates that occur most often in the preliminary angle estimates; and
the processing system is configured to estimate the angular information based on the identified mode of the preliminary angle estimates.

10. The apparatus of claim 1, wherein the processing system is further configured to:
generate a metric indicative of a confidence in the estimated angular information, wherein the metric is related to a width of a distribution of the phase differences or a width of a distribution of the parameters; and
take one or more actions based the metric.

11. The apparatus of claim 10, wherein the one or more actions comprise at least one of:
requesting additional packets for estimating the angular information if the metric is equal to or below a threshold value; or
discarding the estimated angular information if the metric is equal to or below the threshold value.

12. A method for wireless communications by an apparatus, comprising:
detecting a plurality of packets via at least two signal paths;
determining phase differences for the plurality of packets, wherein the phase difference for each packet is determined based on a difference in time that the packet was detected, and
estimating angular information for the packets based on a statistical analysis of at least one of: the phase differences or parameters generated based on the phase differences.

13. The method of claim 12, further comprising estimating a position of the apparatus based on the angular information and a position of a source of the packets.

14. The method of claim 13, further comprising:
generating a packet including the estimated position; and
outputting the generated packet for transmission.

15. The method of claim 12, further comprising:
generating a packet including the angular information; and
outputting the generated packet for transmission.

16. The method of claim 15, wherein:
the generated packet also includes a metric indicative of a confidence in the estimated position.

17. The method of claim 12, wherein the angular information comprises at least one of angle of arrival (AoA) information or angle of departure (AoD) information.

18. (canceled)

19. The method of claim 12, wherein:
the statistical analysis comprises identifying a mode of the phase differences, wherein the mode comprises a phase difference or bin of phase differences that occurs most often in the phase differences; and
the angular information is estimated based on the identified mode of the phase differences.

20. The method of claim 12, wherein:
the parameters generated based on the phase differences comprise individual preliminary angle estimates generated for each packet based on the corresponding phase difference;
the statistical analysis comprises identifying a mode of the preliminary angle estimates, wherein the mode comprises a preliminary angle estimate or bin of preliminary angle estimates that occurs most often in the preliminary angle estimates; and
the angular information is estimated based on the identified mode of the preliminary angle estimates.

21-33. (canceled)

34. A wireless station, comprising:
a receiver configured to detect a plurality of packets via at least two signal paths; and
a processing system configured to
determine phase differences for the plurality of packets, wherein the phase difference for each packet is determined based on a difference in time that the packet was detected, and
estimate angular information for the packets based on a statistical analysis of at least one of: the phase differences or parameters generated based on the phase differences.

35. (canceled)
